(19) United States
(12) Patent Application Publication
(10) Pub. No.: US 2003/0109298 A1
(43) Pub. Date: Jun. 12, 2003

(54) Video game apparatus and motion sensor structure

(75) Inventors: Toshimitsu Oishi, Akashi-shi (JP); Atsushi Yamazaki, Kobe-shi (JP); Toru Takeda, Osaka-shi (JP); Keiichi Matsubara, Kakogawa-shi (JP); Mayu Matsubara, Kakogawa-shi (JP); Hirofumi Mamitsu, Himeji-shi (JP)

Correspondence Address: JORDAN AND HAMBURG LLP, 122 EAST 42ND STREET, SUITE 4000, NEW YORK, NY, 10168, US

(73) Assignee: Konami Corporation, Chiyoda-ku (JP)

(21) Appl. No.: 10/307,608

(22) Filed: Dec. 2, 2002

(30) Foreign Application Priority Data
Dec. 7, 2001 (JP) 2001-374908

(51) Int. Cl. G06F 17/00; A63F 9/24

(52) U.S. Cl. 463/8

(57) ABSTRACT

On the lower surface of a sensor board 23 which serves as a ceiling of a motion sensor structure 20, optical motion sensors 31, 32, 33 are arranged in three row at the front side of a monitor 11, motion sensors 41, 42 are arranged in two rows at the left side of the monitor 11, and motion sensors 51, 52 are arranged in two rows at the right side of the monitor 11, whereby curtain-shaped detection planes are formed below these sensors, and an area surrounded by these detection planes is a play space. When a player moves his arms and legs to intersect with the detection planes while watching images displayed on the monitor 11, such motions are detected.

### BACKGROUND OF THE INVENTION

1. Field of the Invention

The present invention relates to a motion sensor structure for remotely detecting the motion of a player on at least one of planes surrounding a play space, and a video game apparatus for proceeding a game by detecting the motion of the player playing the game while viewing (copying) the motion of a game image on the monitor.

2. Description of the Related Art

Conventionally, there has been known a music game in which note bars scrolling on a monitor screen are successively displayed, a player is urged to operate a controller when the respective note bars reach a reference line displayed at the downstream side of a scrolling direction, and a high evaluation is given when the controller is operated at a good timing by the player. Further, in a fighting game to fight with a character on a screen, detectable elements are mounted at a plurality of positions of a player's body, the motion of the player is detected by sensing these detectable elements by means of a CCD camera or the like, and whether or not the player is properly punching at proper timings is detected to proceed a game.

In the former music game apparatus, the controller is only operated by seeing whether or not the scrolling note bars coincide with the reference line, and a gaming effect lies in the reproduction (performance) of a music in a maximally perfect form by precisely operating the controller. This presents a significance as a music game. Further, in the latter fighting game, the fun of the game lies in dodging the opponent's attack and knocking the opponent out by the player attacking (punching) him, but the content of attack is left up to the player and relative strength is contended.

### SUMMARY OF THE INVENTION

In view of the problems residing in the prior art, an object of the present invention is to provide a video game apparatus with which a player can enjoy a game by being caused to follow predetermined motions while mastering such motions, and a motion sensor structure for detecting the motion of the player in the game.

In order to achieve the object of the present invention, a motion sensor structure for remotely detecting a motion of a player with respect to at least one of imaginary planes surrounding a play space, said motion sensor structure comprising: a first sensor having a first detection distance range for detecting a motion of the player in a direction intersecting one half of a first plane among the planes and the vicinity region of the one half of the first plane, and a second sensor having a second detection distance range for detecting a motion in a direction intersecting the other half of the first plane and the vicinity region of the other half of the first plane.

With this construction, the motion of the player is remotely detected with respect to at least one of the planes surrounding the area where the player plays. A planar plane, which is an imaginary plane, is formed if the play space is in the form of a polygonal column (left, right, front, or back), whereas a curved plane, which is again an imaginary plane, is formed if it is in the form of a cylinder. The motions of the player's arms and legs intersecting with a section of the one plane located in one half, e.g. the upper half of the play space are detected by the first sensor having the first detection distance range, whereas the motions of the player's arms and legs intersecting with a section of the one plane located in the other half, e.g. the lower half of the play space are detected by the second sensor having the second detection distance range. Different motions and the motions of different body parts on the same plane can be detected by the first and second sensors.

These and other objects, features and advantages of the present invention will become more apparent upon a reading of the following detailed description and accompanying drawings.

### BRIEF DESCRIPTION OF THE DRAWINGS

FIG. 1 is a perspective view showing one embodiment of a video game apparatus according to the present invention,

FIG. 2 is a side view in section of the video game apparatus of FIG. 1,

FIG. 3 is a plan view of the video game apparatus of FIG. 1,

FIG. 4 is a perspective view of a motion sensor structure of FIG. 1,

FIG. 5 is a plan view diagrammatically showing a relationship between motion sensors and a player area of a player P,

FIG. 6 is a hardware construction diagram of the video game apparatus,

FIG. 7 is a software block diagram of a control unit,

FIG. 8 is a main flow chart of a game,

FIG. 9 is a flow chart of a game processing,

FIG. 10 is a flow chart showing a subroutine “Stage Selection,”

FIG. 11 is a diagram of a “Degree of Difficulty” selection screen of the game displayed prior to the start of the game as an example of a game section screen,

FIG. 12 is a diagram of a screen used to select “songs” as an example of the game selection screen,

FIG. 13 is a diagram of a screen used to select a “course” as an example of the game selection screen,

FIG. 14 is a diagram showing an exemplary screen image during the game,

FIG. 15 is a diagram showing another exemplary screen image during the game,

FIG. 16 is a diagram showing an exemplary screen image at the end of the game,

FIGS. 17 and 18 are diagrams showing an exemplary result display screen, and

FIG. 19 is a diagram showing an exemplary display screen of a total performance result for four songs in the case of selecting a nonstop course.

### DETAILED DESCRIPTION OF THE PREFERRED EMBODIMENTS OF THE PRESENT INVENTION

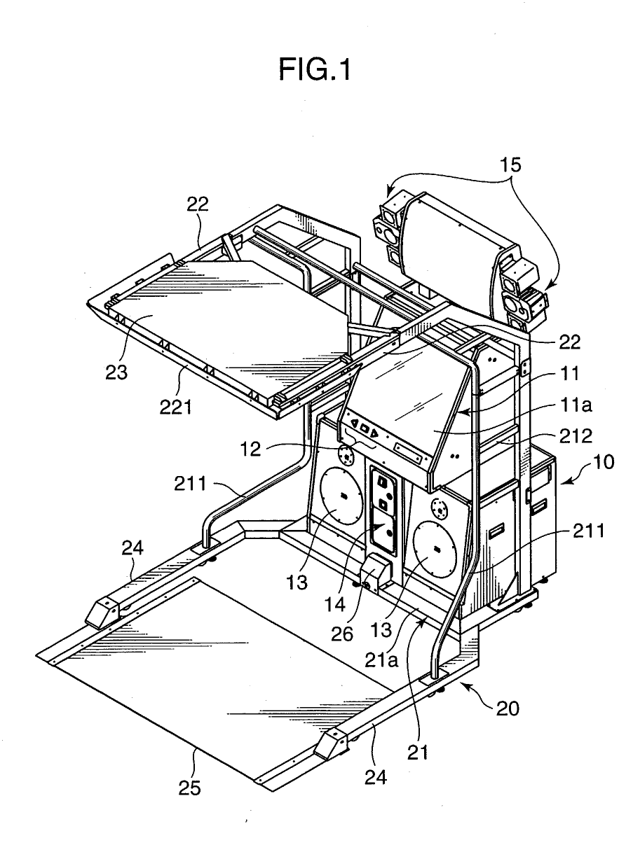

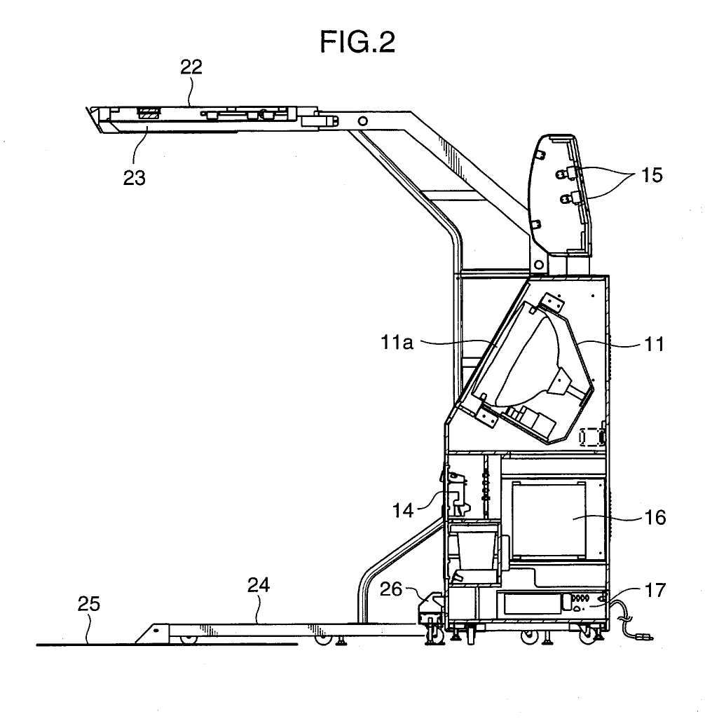

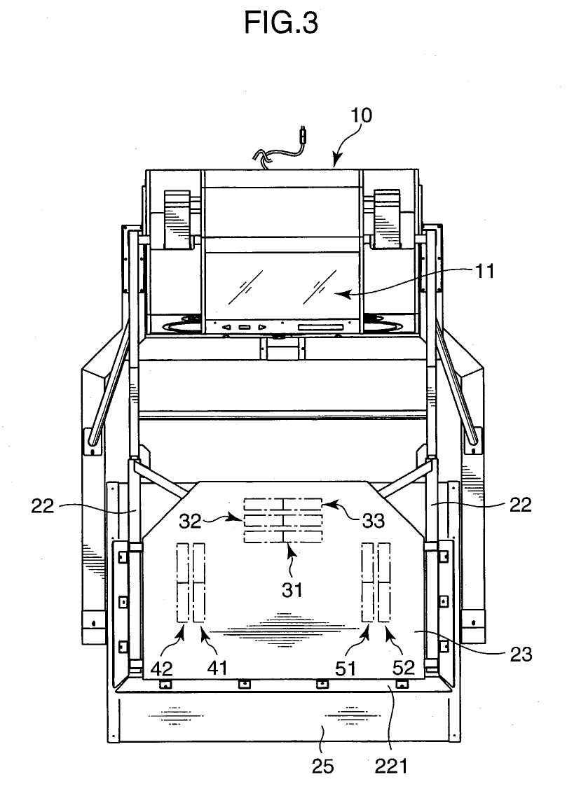

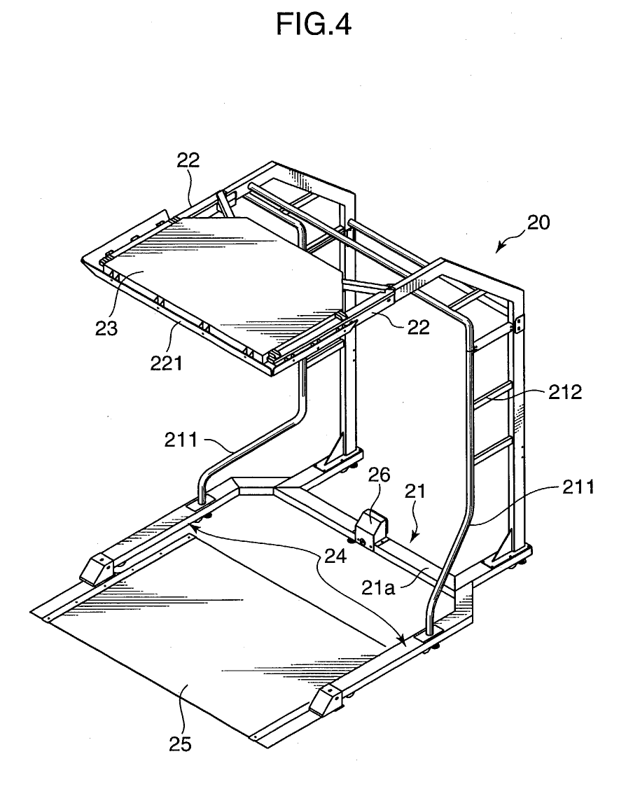

FIG. 1 is a perspective view showing one embodiment of a video game apparatus according to the present invention; FIG. 2 is a side view in section of the video game apparatus of FIG. 1; FIG. 3 is a plan view of the video game apparatus of FIG. 1; and FIG. 4 is a perspective view of a motion sensor structure of FIG. 1. This game apparatus is structurally comprised of a game main unit 10 and a motion sensor structure 20 unitarily or integrally provided in the main game unit 10.

The main game unit 10 is a substantially rectangular parallelepipedic console box, and a monitor of a specified size for displaying game images is provided substantially in the center of the front surface of the main game unit 10, preferably at such a height that a viewing direction coincides with the substantially center of the screen in a normal posture of a player playing a game. The monitor 11 is inclined (leaned) backward by a specified angle, preferably by about 30° as shown in FIG. 2, so that the player can easily see the entire screen along vertical direction. A liquid crystal projector and the like can be adopted as the monitor 11 in addition to a CRT, an LCD, a plasma display. An operation panel provided with selection keys and a confirmation key for instructing the selection of a game and the like is provided immediately below the monitor 11 of the main game unit 10; loudspeakers 13 for presenting sound effects are provided below and at the left and right sides of the operation panel 12; and an insertion device 14 into which a coin or the like is inserted to permit the game is provided between the loudspeakers 13. A plurality of light sources 15 for electric decoration, e.g. three light sources 15 of three primary colors are provided above and at the left and right sides of the insertion device 14 while being faced forward. A circuit board unit 16 carrying a control unit necessary to control a game operation and a power source 17 are provided inside the main game unit 10.

The motion sensor structure 20 is transversely symmetric in this embodiment and includes an integral base frame 21 having a construction capable of holding the main game unit 10 from left and right sides in a standing position, left and right upper arms 22 and left and right lower arms 24 extending horizontally forward from the left and right sides of the upper and lower ends of the base frame 21. The base frame 21 forms a recess which is open backward (U-shaped in plan view) so that the main game unit 10 as a casing of a rectangular column can be inserted from behind into a coupling frame portion 21a at the bottom of the left and right frames having a horizontal portion and a standing portion, in the middle in this embodiment. The base frame 21 also includes reinforcing frames 211, beams 212 and the like to obtain a specified strength. The upper arms 22 are at such a height as to be located above the player and have the leading ends thereof coupled by a coupling arm 221, and a rectangular sensor board 23 is mounted on a horizontal plane surrounded by the left and right upper arms 22 and the coupling arm 221. An area (or a space) between the left and right lower arms 24 serves as a lower boundary of a play space, and a play sheet member 25 for making it easier for the player to see the lower boundary of the play space is mounted by being laid. The sensor board 23 is positioned such that its lower surface overlaps the play space. The play space, hereinafter, is defined as a space between the play sheet member 25 and the sensor board 23.

As indicated by phantom in FIG. 3, a plurality of motion sensors 31, 32, 33, 41, 42, 51, 52 are mounted in a specified arrangement on the lower surface of the sensor board 23. Power cables and signal cables for the motion sensors 31 to 52 are laid between the sensor board 23 and an output box 26 provided in the middle of the coupling frame 21a. In this embodiment, the upper arms 22 are formed into tubes and the inner spaces of the tubes are used as cable-laying paths. Thus, the laid signal cables and power cables cannot be seen from outside and do not get caught, thereby realizing a highly reliable arrangement of the cables. The output box 26 functions as an intermediate terminal (for receiving power inputs for the sensors and outputting detection signals) for the arrangement of the cables with the main game unit 10. Since the motion sensor structure 20 is constructed as above, the game apparatus casing of a column shape which is a general shape can be easily fitted into the recess. Thus, the main game unit 10 can be easily integrated into the motion sensor structure 20 and can be quickly mounted. Further, since the motion sensor structure 20 can be a single member used to mount the sensors, it can be combined with apparatuses such as the main game unit regardless of the kinds of the apparatuses, thereby being better used for general purposes. By providing the output box 26, the motion sensor structure 20 can be easily electrically connected with the apparatuses to be combined. The shape of the motion sensor structure 20 is not limited to that of this embodiment, and it may take any shape provided that it can display similar functions.

Each of the motion sensors 31 to 52 is formed by linearly arraying the same number of optical sensors (necessary number corresponding to the kind of the game) at specified intervals. Each sensor is integrally provided with a light emitting element for emitting an infrared ray having a specified width of directivity and a light detecting element and is mounted while being faced down. Thus, a detection plane (of so-called curtain shape) on which beam-shaped detection ranges of the optical sensors of each motion sensor 31 to 52 are connected in one direction by the width of directivity and the arrangement interval of the optical sensors. When a part of the player's body intersects with or crosses this detection plane, the lights from the light emitting elements are blocked and cannot be received by the corresponding light detecting elements. Motion detection is realized by detecting such a state.

The motion sensors 31, 32, 33 are arranged one after another at a side closer to the monitor 11 (front play space), and the light intensity thereof is set such that the motion sensors 31, 32 at the front side have a detection range for a substantially upper half of the play space over the play sheet member 25 and the motion sensor 33 has such a detection range extending from the bottom of the upper half of the play space to immediately above the play sheet member 25 (a lower half of the play space). Alternatively, in a mode of emitting a light in the form of a pulse, the detection range can also be set by sectioning the pulse by a light detection gate signal synchronous with a light emission timing in order to restrict a detection distance range.

The motion sensors 41, 42 arranged at the left side with respect to the monitor 11. The motion sensor 41 has a detection range for the substantially upper half of the play space over the play sheet member 25 and the motion sensor 42 has a detection range extending from the bottom of the upper half of the play space to immediately above the play sheet member 25 (a lower half of the play space). The motion sensors 51, 52 arranged at the right side with respect to the monitor 11. The motion sensor 51 has a detection range for the substantially upper half of the play space over the play sheet member 25 and the motion sensor 52 has a detection range extending from the bottom of the upper half of the play space to immediately above the play sheet member 25 (a lower half of the play space).

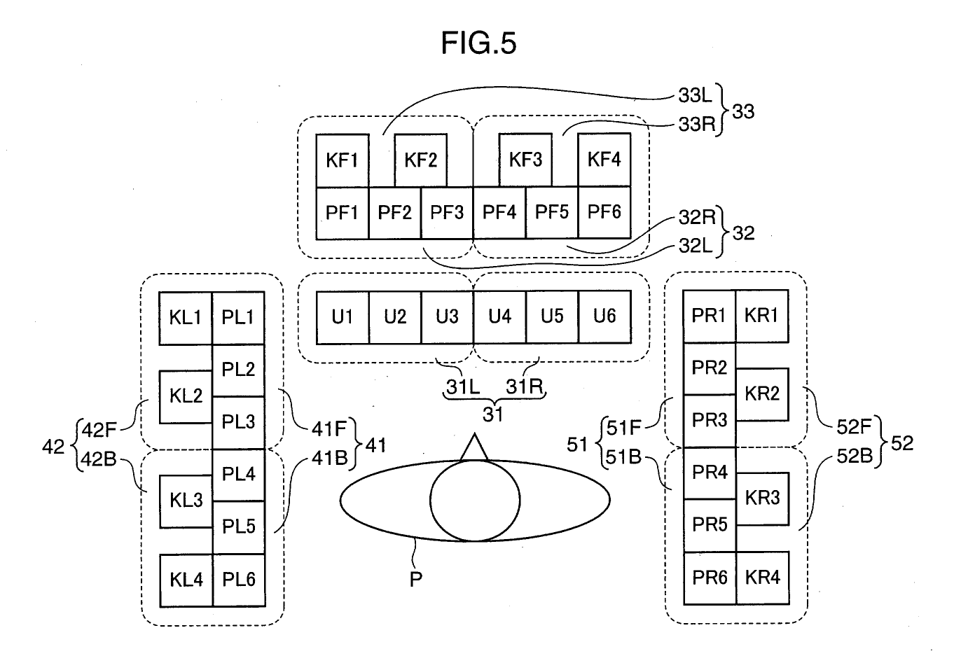

FIG. 5 is a plan view diagrammatically showing a relationship between the motion sensors 31 to 52 and a player P in the play space.

Here, the content of this game is briefly described. In this game, moving images photographed and prepared beforehand to be shown to the player are displayed on the monitor 11. One video character (corresponding to a master) appears in the moving pictures and demonstrates (displays), for example, punches (jabs, straights), uppercuts, hooks, kicks and the like, which are motions of t'ai chi ch'uan, karate, boxing and other martial arts forms, as exemplary performances for guidance. The player tries to move his body while watching the moving images of the exemplary performance. In this game apparatus, the motion of the player's body is detected by the motion sensors 31 to 52, and correlation (coincidence of the kind of the technique, degree of coincidence of the timing of the motion) between the performance on the monitor 11 and the motion of the player is evaluated.

In FIG. 5, the motion sensor 31 functions as an uppercut sensor, wherein a left motion sensor 31L is comprised of sensors U1 to U3 and a right motion sensor 31R is comprised of sensors U4 to U6. The motion sensor 32 functions as a front-punch sensor, wherein a left motion sensor 32L is comprised of sensors PF1 to PF3 and a right motion sensor 32R is comprised of sensors PF4 to PF6. The motion sensor 33 functions as a front-kick sensor, wherein a left motion sensor 33L is comprised of sensors KF1, KF2 and a right motion sensor 33R is comprised of sensors KF3, KF4.

The sensors U1 to U3 detect that the player P has made the same motion as an uppercut at the left side (generally by left arm), whereas the sensors U4 to U6 detect that the player P has made the same motion as an uppercut at the right side (generally by right arm). The above detection is made regardless of which of the sensors U1 to U6 has detected. Further, in the case that the adjacent sensors U1 to U6 have successively outputted detection signals, a left hook is detected if the sensors of an increasing order (from U1 to U6) have detected, whereas a right hook is detected if the sensors of a decreasing order (from U6 to U1) have detected. This also applies to cases where two or more adjacent sensors (for example, the sensors U2, U3, U4) have successively outputted the detection signals.

Similarly, the sensors PF1 to PF3 detect a punching motion to the left (jab, straight, etc.), whereas the sensors PF4 to PF6 detect a punching motion to the right (jab, straight, etc.). The above detection is made regardless of which of the sensors PF1 to PF6 has detected.

The sensors KF1, KF2 detect a forward kicking motion to the left, whereas the sensors KF3, KF4 detect a forward kicking motion on the right hand side. The above detection is made regardless of which of the sensors KF1 to KF4 has detected.

The motion sensor 41 functions as a leftward-punch sensor, wherein a leftward-forward motion sensor 41F is comprised of sensors PL1 to PL3 and a leftward-backward motion sensor 41B is comprised of sensors PL4 to PL6. The motion sensor 42 functions as a leftward-kick sensor (or side kick sensor), wherein a leftward-forward motion sensor 42F is comprised of sensors KL1, KL2, and a leftward-backward motion sensor 42B is comprised of sensors KL3, KL4.

The sensors PL1 to PL3 detect a forward punching motion (jab, straight, etc.) to the left, whereas the sensors PL4 to PL6 detect a backward punching motion (jab, straight, etc.) to the left. The above detection is made regardless of which of the sensors PL1 to PL6 has detected. The sensors KL1, KL2 detect a forward kicking motion to the left, whereas the sensors KL3, KL4 detect a backward kicking motion to the left. The above detection is made regardless of which of the sensors KL1 to KL4 has detected.

The motion sensor 51 functions as a rightward-punch sensor, wherein a rightward-forward motion sensor 51F is comprised of sensors PR1 to PR3 and a rightward-backward motion sensor 51B is comprised of sensors PR4 to PR6. The motion sensor 52 functions as a rightward-kick sensor (side kick sensor), wherein a rightward-forward motion sensor 52F is comprised of sensors KR1, KR2, and a rightward-backward motion sensor 52B is comprised of sensors KR3, KR4.

The sensors PR1 to PR3 detect a forward punching motion (jab, straight, etc.) to the right, whereas the sensors PR4 to PR6 detect a backward punching motion (jab, straight, etc.) to the right. The above detection is made regardless of which of the sensors PR1 to PR6 has detected. The sensors KR1, KR2 detect a forward kicking motion to the right, whereas the sensors KR3, KR4 detect a backward kicking motion to the right. The above detection is made regardless of which of the sensors KR1 to KR4 has detected. Judgments on the kinds of the motions made by the players (performances) as above are made by a control unit to be described.

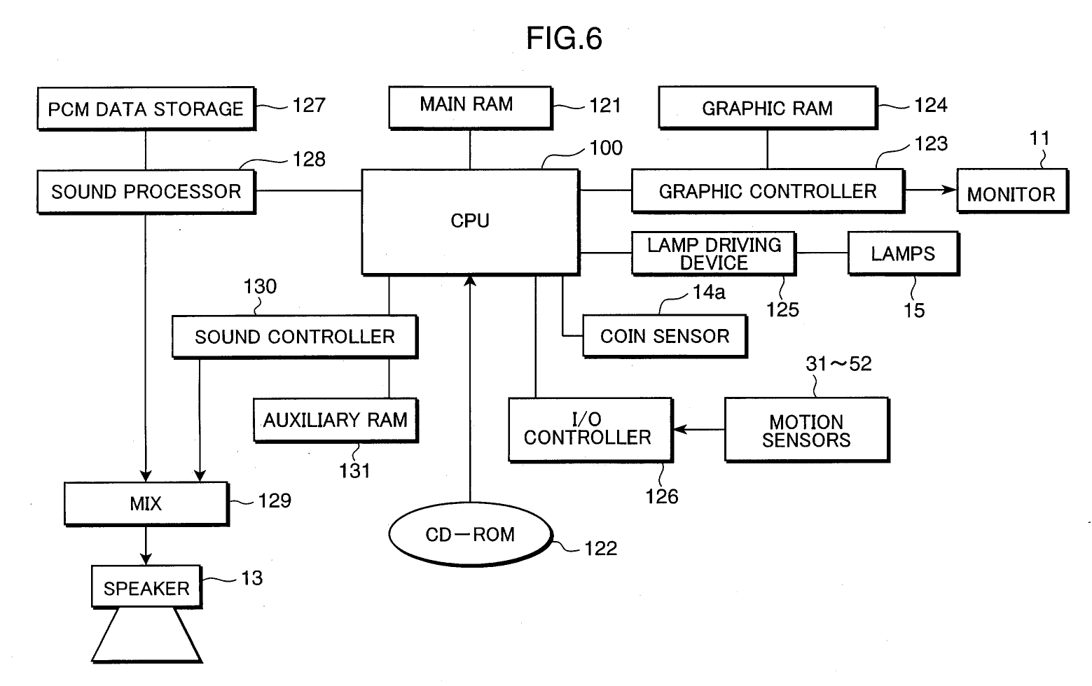

FIG. 6 is a hardware construction diagram of this video game apparatus. The video game apparatus is provided with a control unit (CPU) 1 for receiving the detection signals from the motion sensors to control the progress of the game.

A main RAM 12 for temporarily saving contents of processing including image data is connected with a control unit 100. A CD-ROM 122 made of, e.g. a hard disk serves as a data storage medium for storing a movie (moving pictures) formed by arraying a multitude of frame images in time series to be reproduced in a specified cycle, e.g. a collection of digital data, and various other image data and as a program storage medium for storing a game program. A DVD-ROM may also be used instead as the storage medium. The moving images may be configured using polygon models set in a virtual 3D space. Further, the storage medium may be mounted in the control unit while being set in an unillustrated drive or may be detachable via an unillustrated drive. The image data and the game program may be stored in separate storage mediums.

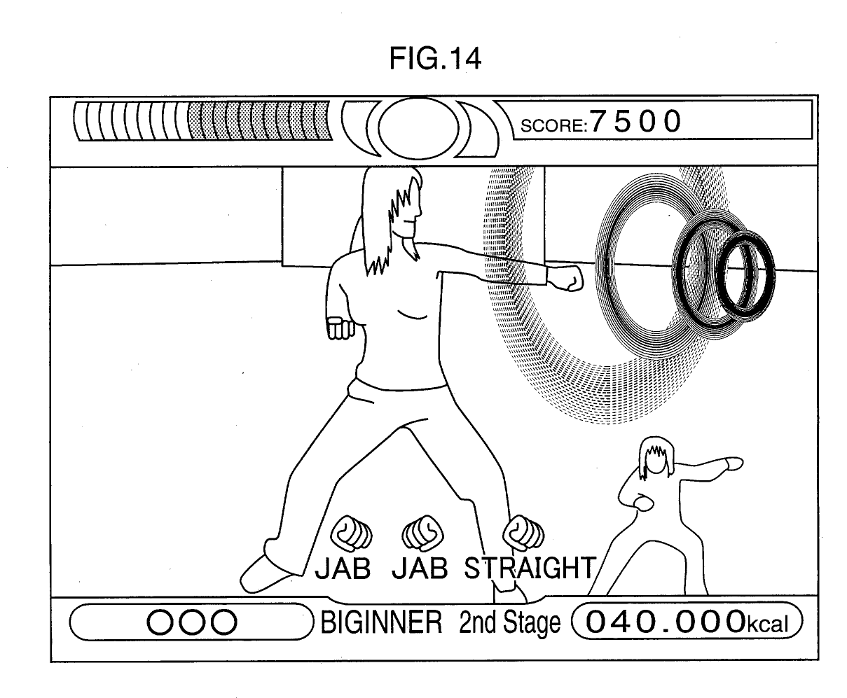

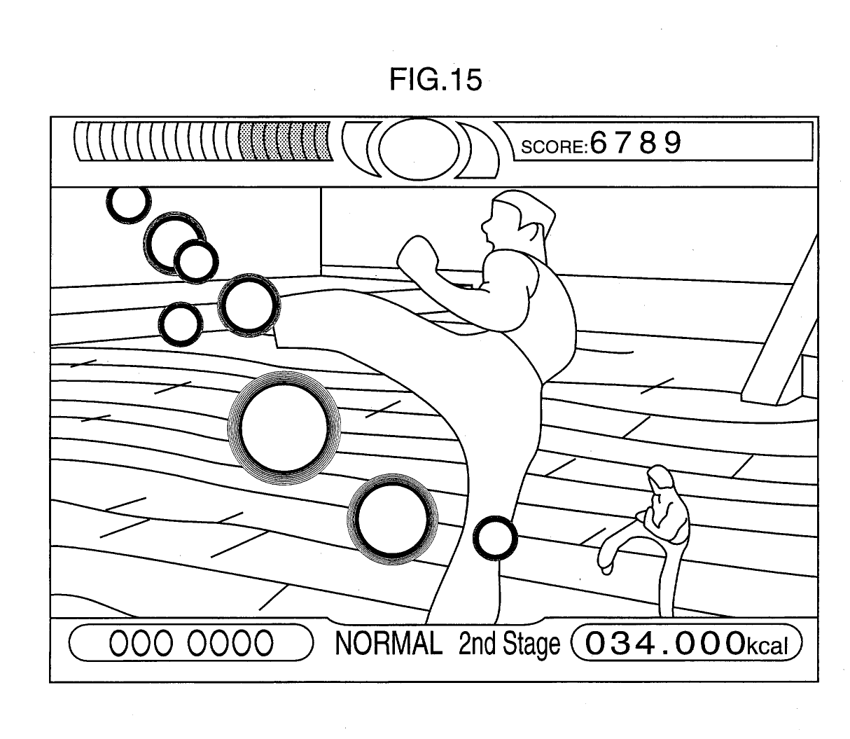

A graphic controller 123 successively takes in the moving images from the CD-ROM 122 temporarily read in the main RAM 121 while being expanded, performs a specified data processing to them, e.g. converts them into RGB data, and repeatedly introduces the processed images to a screen 11a of the monitor 11 in a specified cycle (e.g. 1/60 sec.). In this way, images are displayed as an animation as shown in FIGS. 14 and 15. A graphic RAM 124 temporarily saves the image data being processed.

A lamp driving device 125 outputs a turn-on power signal to make a dramatic electric decoration. An I/O controller 126 takes in the detecting states of the motion sensors 31 to 52 in a specified order and outputs them to the control unit 100.

A PCM data storage 127 stores sound signals representing background music, etc. and those used to guide the contents of operation in a specific compression format (e.g. MP3). These two kinds of sound signals outputted as the game proceeds are stored while being divided into sector units set along an axis of time. A sector information is used to output the sound signal so as to be synchronous with the moving images reproduced in the specified cycle. The PCM data storage 127 also stores time information related to reproduction timings of the sound signals information and contents of instructions. In each sector, an information on note positions is set as a time information so as to correspond to a performance timing of the moving images reproduced in the specified cycle. The note position information may be a set of the sector information and the time information representing the note positions in the sector. An information on the content of instruction is for specifying the content of each motion (performance) of a video character (see FIGS. 14 and 15) appearing in the moving images and is expressed, for example, using a code information. A kind information includes forward left and right punches (jabs, straights, etc.), forward and backward punches to the left and right, forward left and right uppercuts, forward left and right hooks, forward left and right kicks, and forward and backward kicks to the left and right.

A sound processor 128 expands the sound signal of MP3 format and introduces it to a sound mixer (MIX) 129, and outputs a set information of the sector information and the content of instruction to the control unit 100 as a sound reproduction synchronizing signal. A sound controller 130 generates a corresponding sound using an auxiliary RAM 131 in accordance with the progress, of the moving images and a sound output instruction from the control unit 100 generated based on the motion detecting states of the motion sensors 31 to 52, and outputs it to the sound mixer 129. The sound mixer 129 mixes the sound signals from the sound processor 128 and the sound controller 130 and introduces the mixed signal to the loudspeakers 13.

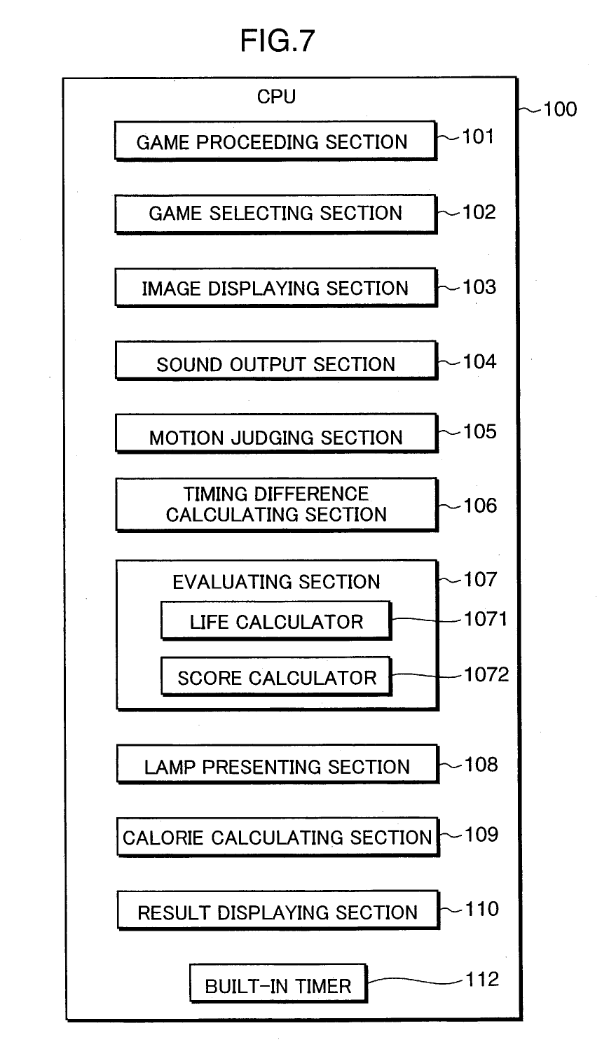

FIG. 7 is a software block diagram of the control unit 100. The control unit 100 controls game signals by reading the game program and the specified image data from the CD-ROM 122 before the start of the game or reading the game program and the image data every time necessary.

A game proceeding section 101 proceeds the game by outputting the moving images and the sound signals, judging and evaluating a degree of precision of the motion made by the player based on the detection information from the motion sensors 31 to 52 and the game program.

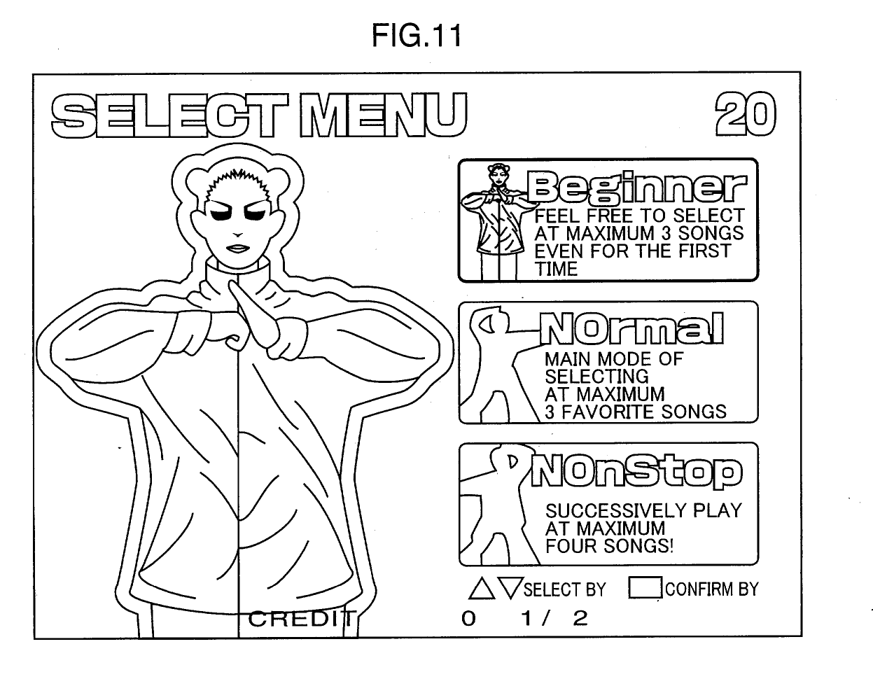

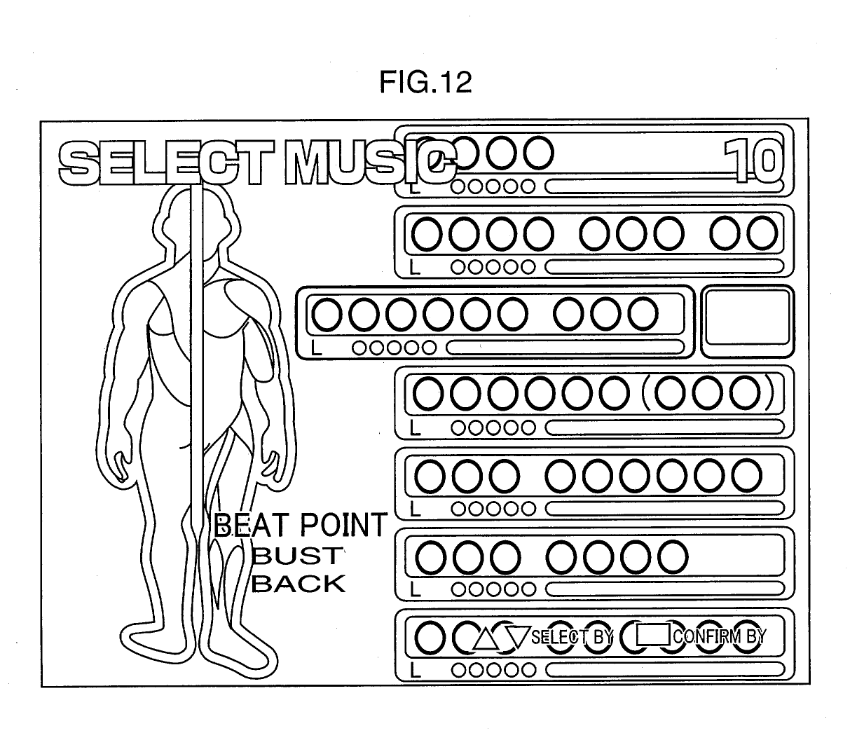

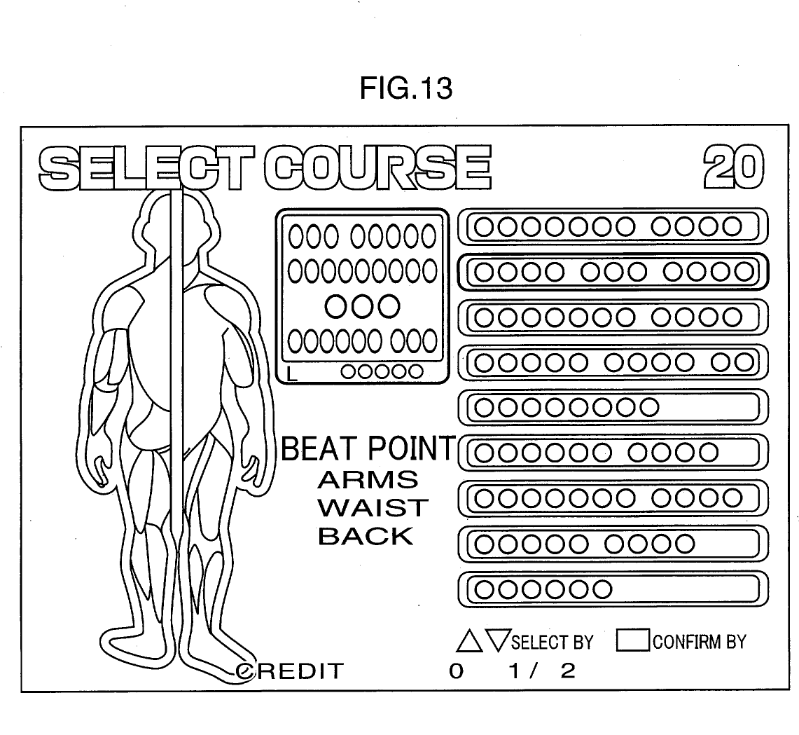

A game selecting section 102 successively displays screens used to select “Degree of difficulty” (see FIG. 11), “Song” (see FIG. 12) and “Course” (see FIG. 13) of the game before the start of the game in accordance with the operation and receives the selection made by operating the selection key and the confirmation key of the operation panel 12. In other words, the game selecting section 102 selects the game instructed by the player. Two or three songs can be selected from an increasing order of the degree of difficulty in the case that there are three degrees of difficulty, and each song is started by instructing the start. In the selection of the “Course”, up to four songs can be selected for a highest degree of difficulty, and four songs are successively played.

An image displaying section 103 successively outputs the moving images in accordance with the note information and displays images corresponding to a degree of precision of the motion made by the player detected by the motion sensors 31 to 52. For example, the image displaying section 103 makes a highlighted presentation display as shown in FIG. 14 or characters such as “GOOD” or “BAD” are displayed when a motion timing coincides or does not coincide, and displays characters “COMBO” when the motion timings successively coincide. The image displaying section 103 also displays a life gauge and a score above the screen and a consumed calorie and the like below the screen while renewing them as the game proceeds. For example, in the case that a course having a low degree of difficulty is selected, the contents of the succeeding motions (e.g. the next three operations: jab, jab, straight) are displayed for guidance by either one or both of characters and images at a specified position of the screen as shown in FIG. 14. A sound output section 104 successively instructs the output of the sound signals of the background music and the guide sound signals in accordance with the sector information. The game proceeding section 101 synchronizes the moving images and the sound signals based on the sector information and the note information.

A motion judging section 105 judges whether or not the motion of the player coincides with the content of instruction. For example, in the case that the content of instruction at a certain point of time is a front-left uppercut, the motion judging section 105 judges whether or not the motion of the player is a front-left uppercut. The motion judging section 105 constantly monitors at least the detection signals of the sensors corresponding to the content of instruction at the present timing, and specifies the motion of the player based on the detecting states of the sensors. Specifically, the motion judging section 105 constantly monitors the content of the present instruction: for example, monitors whether or not the sensors KF to KF4 are in detecting states at a timing when a kicking action to the front is displayed on the monitor 11. Even if the player P makes a long punch, thereby reaching the detection area of the sensor KF1 to KF4 beyond the detection area of the sensors PF1 to PF6, the detection information of the sensors KF1 of the KF4 is ignored and the corresponding kicking motion is judged to have been made since the motion judging section 105 monitors whether or not the kicking motion has been made. As an alternative method for detecting whether or not the corresponding motion has been made, the motion judging section 105 may judge the corresponding motion based on the detecting states of all the motion sensors 31 to 52. In other words, if the sensors PF1 to PF6 and the sensors KF1 to KF4 successively enter their detecting states, the motion of the player is judged to be a punch.

A timing difference calculating section 106 measures a degree of temporal coincidence between the timing of instruction and the detection timings of the motion sensors 31 to 52 using the built-in timer 112 in the case that the motion judging section 105 judges the corresponding motion, and gives an evaluation based on the time difference. This evaluation result is reflected on the score. It does not matter which one of the motion judging section 105 and the timing difference calculating section 106 operates first.

An evaluating section 107 includes a life calculator 1071 and a score calculator 1072. The life calculator 1071 gives a specified life or full life at the start of the game, increases an amount of life corresponding to the time difference in the case that the time difference is equal to or below a threshold value while subtracting an amount of life corresponding to the time difference in the case that the time difference is beyond the threshold value or subtracting a specified amount of life in the case that the motion made by the player does not coincide with the instructed motion. The score calculator 1072 gives a specified maximum point if the timing difference calculated by the timing difference calculating section 106 is “0”, gives a specified point or gives points stepwise if the timing difference is within the specified threshold value, and gives no point if the time difference is beyond this threshold value. The score calculator 1072 gives no point if the motion judging section 105 judges that the motion made by the player does not coincide with the instructed motion. The given points are added up to the present score.

A lamp presenting section 108 instructs to turn the light sources 15 on in accordance with the motion timing of the player P. The presentations made by turning on the light sources 15 are made different between the case where the time difference is within the threshold value and the case it is beyond the threshold value, so as to give a suitable presentation when the player succeeds in making a correct motion in response to the instruction. As described above, the image displaying section 103 superimposes the highlighted display and the other contents of display on the moving images on the screen 11a in the case that the player succeeded in making the correct motion while superimposing the corresponding contents of display thereon in other cases.

A calorie calculating section 109 has a unit consumed calorie set for a reference weight according to the kind of the motion and adds calorie values corresponding to the respective motions judged by the motion judging section 105. This section 109 adds the calorie values regardless of whether or not the motion judging section 105 judged the motion of the player to coincide with the instructed motion or whether or not the timing difference between the timing of the player's motion and the timing of instruction is within the threshold value, so that the calorie consumed by the player making the motions can be precisely calculated. For a better precision, a ratio of an entered weight to the reference weight may be calculated and the consumed calorie may be calculated by multiplying the unit calorie value by the calculated ratio in a mode in which the weight of the player is entered. The weight may be entered using a tenkey displayed on the screen 11a for the entry of the weight or selecting one of various weight values, for example, in the form of character buttons of “Heavy”, “Medium” and “Light” displayed on the screen 11a using the selection keys of the operation panel 12. Alternatively, the play sheet member 25 in the play space may have a built-in pressure sensitive sensor and the weight of the player may be automatically detected based on a pressure level when the player steps on the play sheet member 25.

The game proceeding section 101 also judges the end of the game. The game is forcibly ended when the life reaches a specified low level, e.g. “0” or the selected courses are all completed with the life maintained at or above a specified low level.

A result displaying section 110 displays the score, the consumed calorie, the maximum combo number and an accomplishment rate for each song and displays a total result in the case of the “course”.

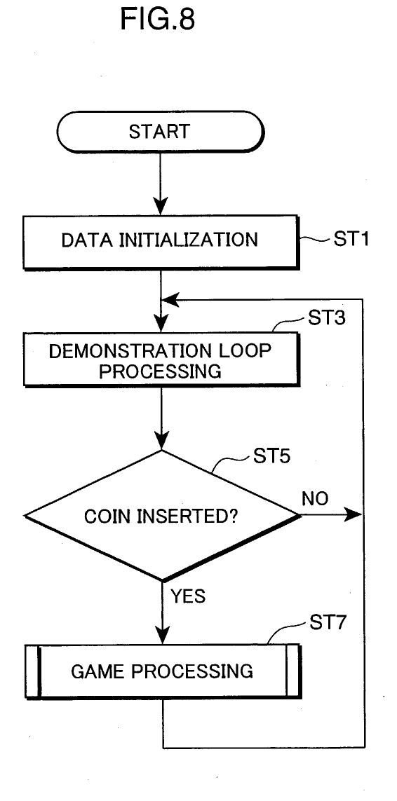

FIG. 8 is a main flow chart of this game. In FIG. 8, when the main power source of the apparatus is turned on, the data are first initialized (Step ST1) and a demonstration loop processing is then entered (Step ST3). The demonstration loop processing is to display a warning (warning of the prohibition on copying by the copyright), demonstration images (movie), and a game demonstration to show states of the game or how to play the game. When the coin sensor 14a detects the insertion of a coin in this state (YES in Step ST5), a “Game Processing” is started (Step ST7).

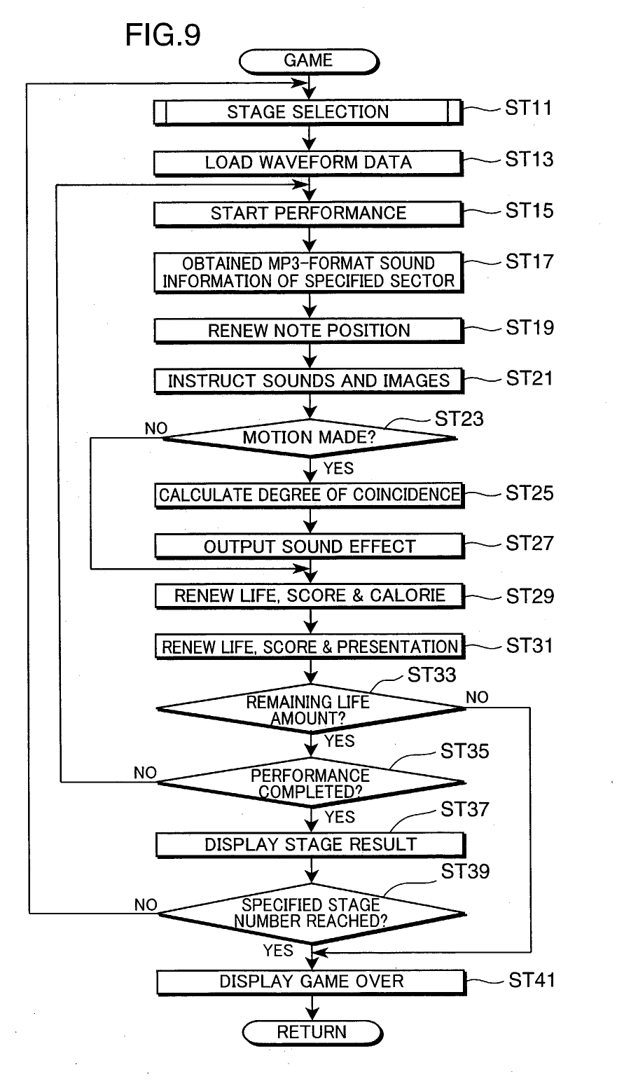

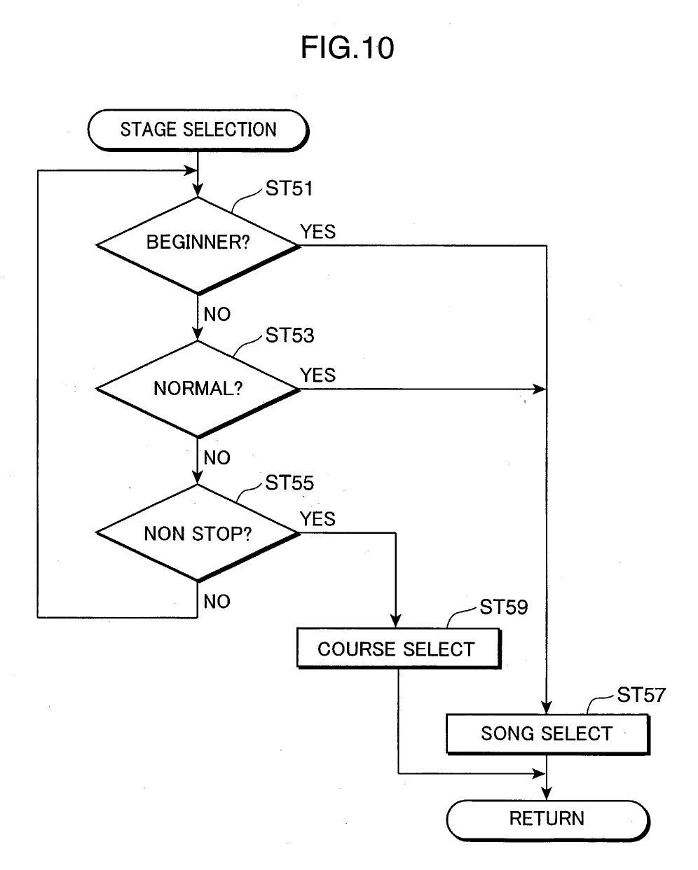

FIG. 9 is a flow chart of the “Game Processing”. When the game is started, a “Stage Selection” is first executed (Step ST11). Here, the content of the “Stage Selection” is described with reference to a flow chart of FIG. 10. A level is selected from “Beginner (Easy)”, “Normal (Medium)” and “Nonstop (Difficult)” corresponding to degrees of game difficulties. When “Beginner (Easy)” is selected (YES in Step ST51), up to two songs are made individually selectable (Step ST57). When “Normal (Medium)” is selected (YES in Step ST53), up to three songs are made individually selectable (Step ST57). When “Nonstop (Difficult)” is selected (YES in Step ST55), a “Course Select” is selected (Step ST59) and four desired songs are made individually selectable (Step ST57).

Referring back to FIG. 9, upon the completion of the stage selection, the waveform data of the moving images are loaded to transfer the moving image data to the main RAM 121 (Step ST13). Then, the game is started, i.e. the performance is started (Step ST15). At the start of the performance, the moving images are continuously reproduced in the aforementioned specified cycle and the sound information of MP3 format of the specified sector is taken out along the axis of time from the PCM data storage 127 (Step ST17). Subsequently, the note position (corresponding to the timing information) where the content of instruction corresponding to the sector information of the sound signal is stored is renewed by a next note position (Step ST19). The content of instruction at the renewed note position is outputted to the control unit 100, and then the background music and the sound signals for guidance stored in this sector are outputted to the loudspeakers 13 and the moving images are outputted to the monitor 11 (Step ST21).

Subsequently, the motion of the player is judged (Step ST23). Specifically, the detection results of the motion sensors 31 to 52 are taken in and the motion of the player is judged to be correct if the following two conditions are met: the detection results have been obtained within a specified threshold time before and after the reproduction timing of the note position; and the content of instruction at the note position and the detected motion coincide with each other (Step ST23). In the case of the correct motion, the time difference is calculated based on the content of instruction at the note position and the detection timing (Step ST25). The sound effects and the electric decorations prepared beforehand in correspondence with the time differences are made (Step ST27). They differ depending on, for example, whether the time difference is “0” or just within the threshold value, but at least the sound effect is always given.

The life value, the score, the consumed calorie value to be added are calculated by the aforementioned method based on the time difference information and added to the present values (Step ST29). The content of display on the screen 11a is renewed by the added results (Step ST31).

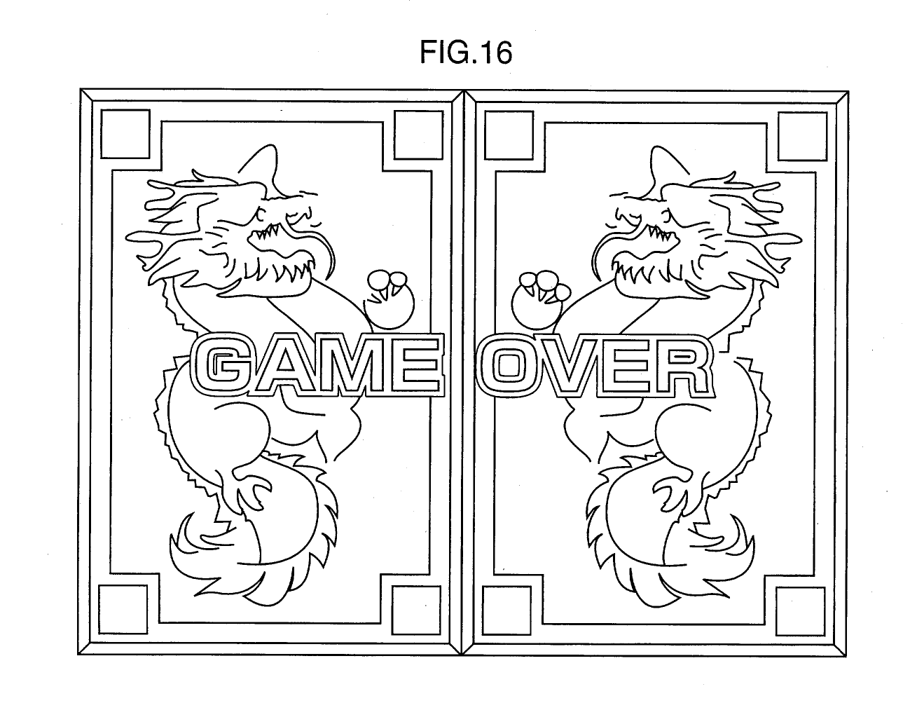

It is then discriminated whether or not there still remains the life amount (Step ST33). The game is forcibly ended as game over when the life amount reaches the specified low level or below (Step ST41). The game-over screen is made by such a presentation display as to close symmetric left and right doors as shown in FIG. 16. The game proceeding section 101 makes such a presentation display as to close the doors quickly (with force) when the game is forcibly ended halfway while closing them slowly at lower speed than in the former case when the game is ended upon being played till the end. On the other hand, if there still remains the life amount, it is judged whether or not the performance, i.e. one song (one stage) has been completed (Step ST35). If one song has not been completed, Step ST15 follows in which the data including the next sound signal and the next content of instruction are outputted to continue the game.

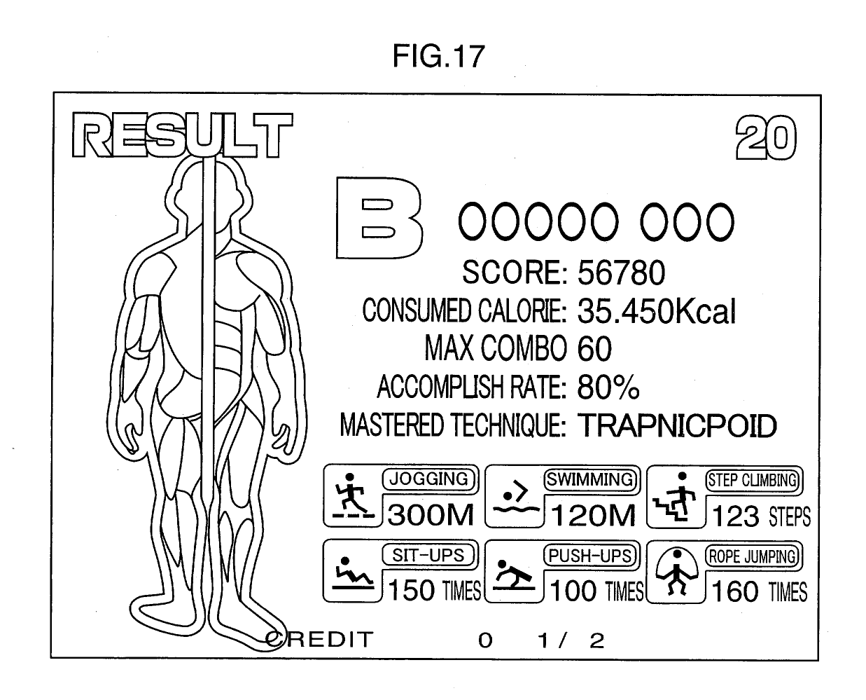

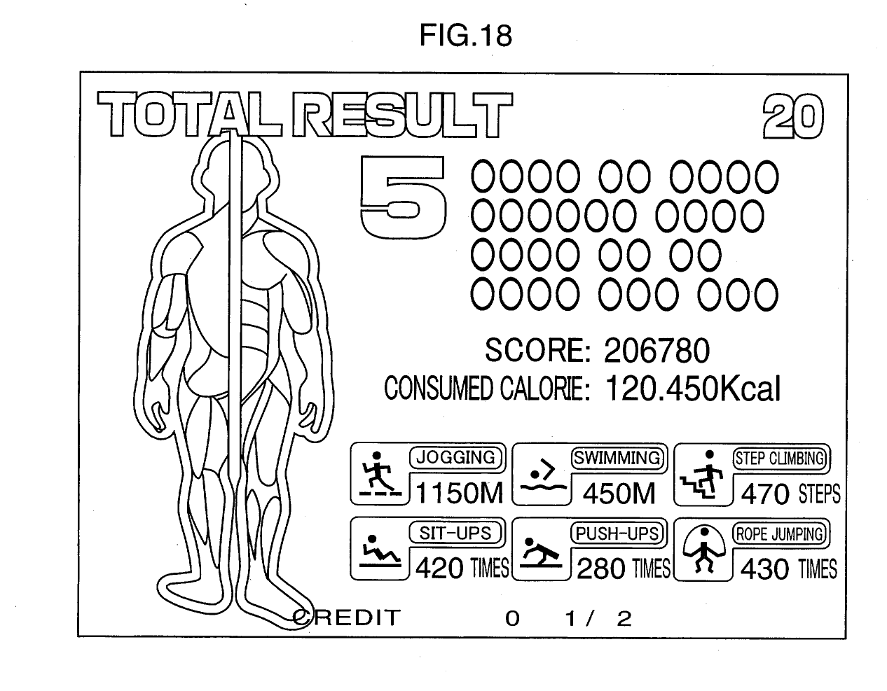

If one song has been completed in Step ST35, the result is displayed as shown in FIG. 17 (Step ST37) upon judging that one stage has been completed. Here, the score, the consumed calorie, the maximum combo number and an accomplishment rate are displayed, and the consumed calorie is presented as exercise amounts in other kinds of exercises, so that the player can easily image the exercise amount. For example, numerical values converted in jogging, swimming, step-climbing, sit-ups, push-ups, and rope jumping are shown. It is then judged whether or not a predetermined number of stages, e.g. three songs (three stages) in the case that the normal course has been selected, have been completed. Unless the predetermined number of stages have been completed, the next stage is started in Step ST11. On the other hand, if the predetermined number of stages have been completed, this subroutine returns to the main routine of FIG. 8 upon judging that the game is over (Step ST41). Then, the total result of the performances for four songs as shown in FIG. 18 is displayed.

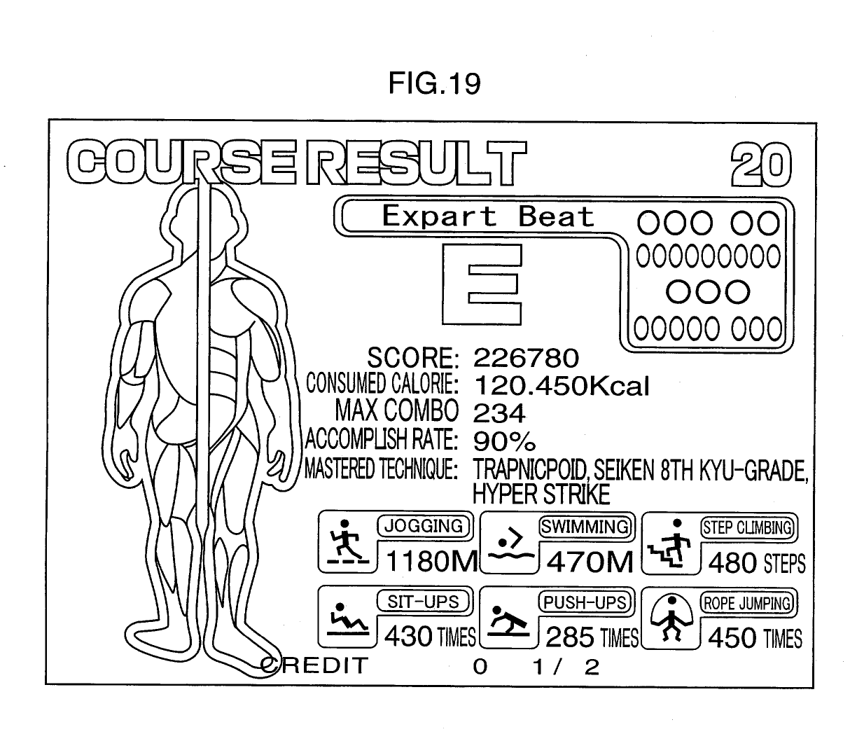

In the case that the nonstop course is selected, a total result of the performances for four songs as shown in FIG. 19 is displayed.

The present invention may be embodied as follows.

(1) Although the sensing area of the motion sensors include the curtain-shaped range on the plane substantially normal to the front plane and the vertical planes at the left and right sides of the former range, it may include only the front plane or a horizontal plane above the player's head.

(2) Although the motion sensors use infrared rays as detecting mediums in order to eliminate the influence of disturbance light, they may use extreme infrared rays or ultrasonic waves in order to further increase a detection precision. Particularly, by cyclically sending and receiving an ultrasonic pulse, even the height of the motion can be precisely detected. Any noncontact sensor can be used provided it can remotely detect a motion.

(3) Although the motion sensors are divided into 31(31L, 31R), 32(32L, 32R), 33(33L, 33R), 41(41F, 41B), 42(42F, 42B), 51(51F, 51B) and 52(52F, 52B), they may be more roughly divided into (31L, 31R), (32L, 33L), (32R, 33R), (41F, 42F), (41B, 42B), (51F, 52F) and (51B, 52B). With such motion sensors, forward motions (to the left and right) and left and right motions (to the front and back) can be detected.

(4) A moving speed can be calculated based on a difference between a detection time of a motion sensor within the play space and that of a motion sensor outside the play space, and such a speed can be reflected on the progress of the game. For example, if a precise kicking or punching motion is made at a high speed, added points may be given to the evaluation or the life may be correspondingly increased, or it may be considered to display motions of even higher level on the screen than the course set at the start of the game. Further, the amount of consumed calorie may be changed depending on the speed.

(5) Although the game is designed to enable the forms and techniques of t'ai chi ch'uan and martial arts to be mastered in the foregoing embodiment, the present invention is not limited thereto and is also applicable to such a game as to follow the action of a video character, e.g. choreography or to such a game as to evaluate whether or not a player has imitated the choreography upon singing a choreographed song using a Karaoke machine. Of course, the evaluation may be given based on a sum of the evaluation given to Karaoke singing and the one given to the imitation of the choreography. Further, the detection according to the present invention is not limited to the detection of body parts of the player. A simulated member, for example, a simulated racket may be detected in a game desired to master a tennis at a tennis school.

(6) The motion sensor structure for remotely detecting the motion of the player with respect to at least one of the planes surrounding the play space may include a plurality of sensors having different detection distance ranges along vertical direction. For example, in a mode adopting three motion sensors, a plurality of different areas such as a bottom area, a middle area and an upper area along vertical direction may be set as detection areas, and different motions can be detected in various height areas. The mount positions of the respective sensors are not limited, for example, to the upper end of the play space. The sensors may be mounted at lateral ends or may be mounted at different ends. The mount positions of the sensors may be suitably set depending on the kind of the game.

In summary, the present invention takes a form of a motion sensor structure for remotely detecting a motion of a player with respect to at least one of planes surrounding a play are. The motion sensor structure comprises: a first sensor having a first detection distance range for detecting a motion of the player in a direction intersecting one half of a first plane among the planes, forming the play space, and a second sensor having a second detection distance range for detecting a motion in a direction intersecting the other half of the first plane.

With this construction, the motion of the player is remotely detected with respect to at least one of the planes surrounding the area where the player plays. An imaginary planar plane (left, right, front or back) is formed if the play space is in the form of a polygonal column, whereas a curved plane, which is also an imaginary plane, is formed if it is in the form of a cylinder. The motions of the player's arms and legs intersecting with one half of the one plane, e.g. the upper half of the play space are detected by the first sensor having the first detection distance range, whereas the motions of the player's arms and legs intersecting with the other half of the one plane, e.g. the lower half of the play space are detected by the second sensor having the second detection distance range. Different motions and the motions of different body parts on the same plane can be detected by the first and second sensors.

In the motion sensor structure as described in the above, the first and second sensors can be arranged at proximate positions on a plane intersecting with said first plane at an end of the first plane. With this arrangement, since the first and second sensors can be arranged substantially at the same position, a common mounting member can be, for example, used to improve a mounting precision. Further, since no sensor is present at the other end of the one plane, the motions of the player are not inadvertently restricted.

In the aforementioned motion sensor structure, the first and second sensors can be arranged at an upper part of the play space, the first plane is a vertical plane, the one half of the first plane is an upper half, and the other half of the first plane is a lower half. With this arrangement, since the first and second sensors have the detection distance ranges to detect the upper half and the lower half of the one surface as a sensing area, respectively, the motions of the player's different body parts and different motions can be distinguishably detected.

In addition, in the aforementioned motion sensor structure, the first plane defines the front plane of the play space, and sensors identical with said first and second sensors are arranged for sensing the motions of the player in the play space with respect to left and right planes intersecting with and at the laterally opposite sides of the first plane. With this construction, since the similar detection planes are formed for detecting the motions of the player with respect to the left and right sides of the front plane, more variety of motions can be detected.

Furthermore, motion sensor structure preferably comprise a standing base frame formed by coupling a left frame and a right frame each having a horizontal portion and a standing portion such that a recess into which a column-shaped casing is fit is formed below the left and right frames, and a ceiling surface formed by providing a horizontally extending portion at the upper end of the base frame, and the ceiling surface is formed as an upper position of the play space where the first and second sensors are arranged. With this construction, since the casing having a column-shape which is a general shape can be easily fitted into the recess, the casing and the sensor structure can be easily integrated and quickly mounted. Since the sensor structure is a single member used to mount the sensors, it can be combined with apparatuses such as a main game unit regardless of the kinds of the apparatuses, thereby being better used for general purposes.

In the motion sensor structure as described in the above, the base frame can be in a tubular form, a sensor signal output terminal is provided at the bottom part of the-base frame, and signal cables connecting the first and second sensors and the sensor signal output terminal can be introduced through the tube of the base frame. With this construction, the laid signal cables cannot be seen from outside and do not get caught, thereby realizing a highly reliable arrangement of the cables. Further, the sensor structure can be easily connected with various apparatuses.

Furthermore, a motion sensor structure as described in the above may further comprise a third sensor having the first detection distance range for detecting a motion of the player in the play space in a direction intersecting with a plane parallel with the first plane within the play space. With this construction, such motions as to intersect only with the detection plane of the third sensor are made detectable, making it possible to increase the kinds of detectable motions with respect to the forward direction.

Moreover, wherein the first detection distance range can be set to cover from an upper part position of the play space to a height position corresponding to the height of the waist of an average player. With this construction, the motions of the player's arms and those of the player's legs can be easily detected by the first sensor and the second sensor, respectively.

Yet moreover, an each of the first and second sensors is preferably an integral construction of a sending device for sending a detection medium and a sensing device for sensing the returned detection medium. This construction enables remote detection. In sensors using infrared rays and ultrasonic waves are used as the detection medium, precise detection can be made without being influenced by disturbance light.

Furthermore, each of the first and second sensors can be constructed by arraying a plurality of unit sensors in a direction parallel with the one plane, the unit sensors being adapted to send the detection medium at a beam-shaped width of directivity. With this construction, the curtain-shaped detection plane can be formed by the beam-shaped detection ranges only by arraying the same sensors.

The present invention also takes a form of a motion sensor structure for remotely detecting a motion of a player with respect to one of planes surrounding a play space of a player, comprising a plurality of sensors having different detection distance ranges with respect to vertical direction. With this construction, a plurality of different areas can be set as detection areas along vertical direction, and different motions can be detected in various height ranges.

The present invention also takes a form of a video game apparatus which comprises: a monitor provided at a specified height position of the front surface of a game apparatus casing for displaying game images; a motion sensor structure provided at the front side of the game apparatus casing while being faced toward a play space, said motion sensor structure remotely detecting a motion of a player with respect to at least one of planes surrounding a play space, said motion sensor structure including: a first sensor having a first detection distance range for detecting a motion in a direction intersecting with one half of a first plane among said planes, and a second sensor having a second detection distance range for detecting a motion in a direction intersecting with the other half of the first plane; instruction information storage means for storing moving images used to instruct various motions to a player in relation to contents of instructions and a timing information; display control means for displaying the moving images on the monitor; judging means for judging the motion of the player based on a detection result from the sensor structure, the content of instruction and the timing information every time the motion is instructed; and evaluating means for evaluating a play result based on the judgment result. With this construction, the game images are displayed on the monitor by the display control means, and the player plays the game in the play space while watching the monitor screen. The moving images used to instruct various motions to the player are stored in relation to the contents of instructions and the timing information in the instruction information storage means, and the player's motion is judged based on the detection result of the sensor structure, the content of the instruction and the timing information every time the moving images displayed on the monitor instruct the motion. The play result is evaluated based on the judgment result. Thus, the game can be proceeded while making it unlikely for the motions to be restricted.

This application is based on Japanese patent application serial No. 2001-374908, filed in Japan Patent Office on Dec. 07, 2001, the contents of which are hereby incorporated by, reference.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A motion sensor structure for remotely detecting a motion of a player with respect to at least one of planes surrounding a play space, said motion sensor structure comprising:
a first sensor having a first detection distance range for detecting a motion of the player in a direction intersecting one half of a first plane among the planes forming the play space and vicinity of the half of the first plane, and
a second sensor having a second detection distance range for detecting a motion in a direction intersecting the other half of the first plane and the vicinity of the other half of the first plane.

2. A motion sensor structure according to claim 1, wherein the first and second sensors are arranged at proximate positions on a plane intersecting with said first plane at an end of the first plane.

3. A motion sensor structure according to claim 1, wherein the first and second sensors are arranged at an upper part of the play space, the first plane is a vertical plane, the one half of the first plane is an upper half, and the other half of the first plane is a lower half.

4. A motion sensor structure according to claim 3, wherein the first plane defines the front plane of the play space, and sensors identical with said first and second sensors are arranged for sensing the motions of the player in the play space with respect to left and right planes intersecting with and at the laterally opposite sides of the first plane.

5. A motion sensor structure according to claim 3, comprising a standing base frame formed by coupling a left frame and a right frame each having a horizontal portion and a standing portion such that a recess into which a column-shaped casing is fit is formed below the left and right frames, and a ceiling surface formed by providing a horizontally extending portion at the upper end of the base frame, and the ceiling surface is formed as an upper position of the play space where the first and second sensors are arranged.

6. A motion sensor structure according to claim 5, wherein the base frame is tubular, a sensor signal output terminal is provided at the bottom part of the base frame, and signal cables connecting the first and second sensors and the sensor signal output terminal are introduced through the tube of the base frame.

7. A motion sensor structure according to claim 4, further comprising a third sensor having the first detection distance range for detecting a motion of the player in the play space in a direction intersecting with a plane parallel with the first plane.

8. A motion sensor structure according to claim 3, wherein the first detection distance range covers from an upper part position of the play space to a vertical position corresponding to the height level of the waist of an average player.

9. A motion sensor structure according to claim 1, wherein each of the first and second sensors is an integral construction of a sending device for sending a detection medium and a sensing device for sensing the returned detection medium.

10. A motion sensor structure according to claim 9, wherein each of the first and second sensors is constructed by arraying a plurality of unit sensors in a direction parallel with the one plane, the unit sensors being adapted to send the detection medium at a beam-shaped width of directivity.

11. A motion sensor structure for remotely detecting a motion of a player with respect to one of planes surrounding a play space of a player, comprising a plurality of sensors having different detection distance ranges with respect to vertical direction.

12. A video game apparatus comprising:
a monitor provided at a specified height position of the front surface of a game apparatus casing for displaying game images;
a motion sensor structure provided at the front side of the game apparatus casing while being faced toward a play space, said motion sensor structure remotely detecting a motion of a player with respect to at least one of planes surrounding a play space, said motion sensor structure including:
a first sensor having a first detection distance range for detecting a motion in a direction intersecting with one half of a first plane among said planes, and
a second sensor having a second detection distance range for detecting a motion in a direction intersecting with the other half of the first plane;
instruction information storage means for storing moving images used to instruct various motions to a player in relation to contents of instructions and a timing information;
display control means for displaying the moving images on the monitor;
judging means for judging the motion of the player based on a detection result from the sensor structure, the content of instruction and the timing information every time the motion is instructed; and
evaluating means for evaluating a play result based on the judgment result.
